(19) United States
(12) Patent Application Publication
(10) Pub. No.: US 2007/0169426 A1
(43) Pub. Date: Jul. 26, 2007

(54) Window template and art viewer

(76) Inventor: David Frank Allen, Arlington, TX (US)

Correspondence Address: GUY V. MANNING, 1407 TEXAS STREET, SUITE 102, FORT WORTH, TX, 76102, US

(21) Appl. No.: 11/339,072

(22) Filed: Jan. 25, 2006

(51) Int. Cl. E06B 3/66

(52) U.S. Cl. 52/204.59

(57) ABSTRACT

A planar steel template the shape of a desired opening to be cut into a fence or wall. The template is affixed to fence pickets or over the top of sheet rock or other wallboard covering the structural members of a wall. Once the template has been fastened in place, an opening through the wall or fence shaped to the inside of the template can be cut away. No further framing or reinforcing is needed as the template supports the severed structural members. An adjustable window set fits inside the resulting opening and extends through the fence or wall, and facie boards sandwich the fence and cover the template. A decorative insert comprising wrought iron, stained glass or the like fits within the window set to decorate and/or limit intrusion through the opening.

### BACKGROUND OF THE INVENTION

1. Field of the Invention

This invention relates generally to window sets and particularly to templates for aiding in installation of window sets in walls or fences. More particularly, this invention relates to a sacrificeable, structural, permanent template for cutting window openings and a corresponding window set with an insert that displays art within the window opening.

2. Description of Related Art

Apparatus and methods for cutting openings in partitions such as fences or walls for insertion of windows and doors are relatively commonplace. Most require a separate structural frame for interrupting vertical members of the partition such as pickets or internal wall studs. The window set then may be attached to the frame but bears no load itself. Less commonly, temporary shoring supports the studs until the window set itself can be inserted and secured to take their place.

In both cases, horizontal structural members extend through the wall at the ends of the remaining segments of vertical members, thereby giving them a surface against which to bear, while replacement vertical members support the horizontal members from a laterally shifted position, thereby opening the space between such vertical members for the window set. Such structural frames must be hefty and usually must be installed piece by piece rather than as a prefabricated unit. Means for simultaneously supporting vertical members while cutting openings through them and then inserting window sets, without need for additional lateral support members, would create economies of cost and time for selected installations.

Perimeter fences for yards commonly comprise regularly spaced posts spanned by two to three horizontal rails supporting vertical pickets. Such fences serve both as visual barriers and security means, as well as often confining pets. They usually are at least six to eight feet high, thereby interrupting line of sight for most people standing at grade, and they seldom are made from materials which permit viewing through them, in accordance with the visual barrier motive. On occasion, however, it can be desirable to provide visual ports through such fences to permit limited viewing at selected locations by humans or pets. Merely cutting a hole in the pickets of such fences leaves them unsupported unless adequate framing is provided around the opening. Conventional window framing, however, usually weighs too much for such pickets and the fence itself. A need exists for inexpensive and light weight means for framing such viewing ports through picket fences.

### SUMMARY OF THE INVENTION

Accordingly, it is an object of this invention to provide a template for supporting facial wall elements around a viewing port.

It is another object of this invention to provide a template for assisting in inserting window sets through fences and walls.

It is another object of this invention to provide a template for window sets which may be sacrificed and left in place.

It is yet another object of this invention to provide a window set and installation template that incorporates art inserts within the window opening.

The foregoing and other objects of this invention are achieved by providing a planar steel template the shape of a desired opening to be cut into a fence or wall. The template is affixed to fence pickets or over the top of sheet rock or other wallboard covering the structural members of a wall. Once the template has been fastened in place, an opening through the wall or fence shaped to the inside of the template can be cut away. No further framing or reinforcing is needed as the template supports the severed structural members. An adjustable window set fits inside the resulting opening and extends through the fence or wall, and facie boards sandwich the fence and cover the template. A decorative insert comprising wrought iron, stained glass or the like fits within the window set to decorate and/or limit intrusion through the opening.

### BRIEF DESCRIPTION OF THE DRAWINGS

The novel features believed characteristic of the present invention are set forth in appended claims. The invention itself, however, as well as a preferred mode of use and further objects and advantages thereof, will best be understood by reference to the following detailed description of an illustrative embodiment when read in conjunction with the accompanying drawings, wherein:

FIG. 1 depicts a portion of a fence with the present invention installed and shown in cutaway perspective and including decorative art.

FIG. 2 shows the present invention of FIG. 1 in perspective view without decorative art.

FIG. 3 shows a section of the fence and the present invention as indicated in FIG. 1.

FIG. 4 details a side view of the components of the present invention in exploded, relative positions.

FIGS. 5A-5C show the steps in installing the present invention into the fence of FIG. 1.

### DETAILED DESCRIPTION OF A PREFERRED EMBODIMENT

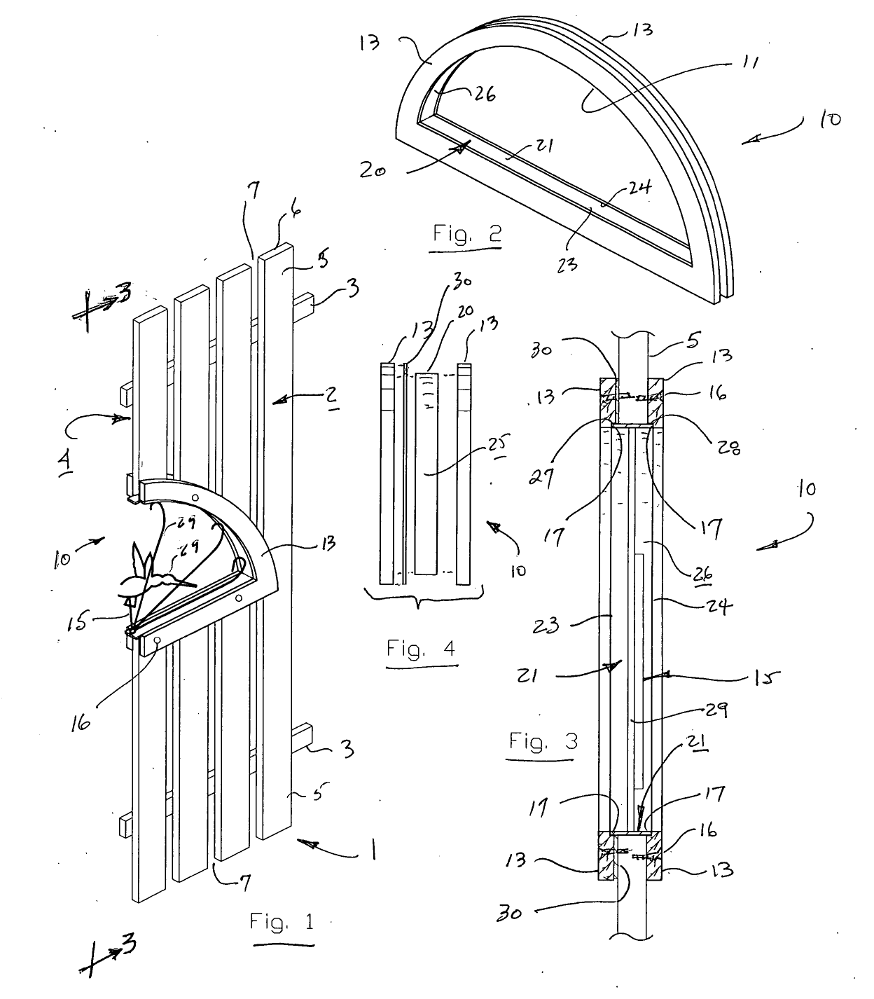

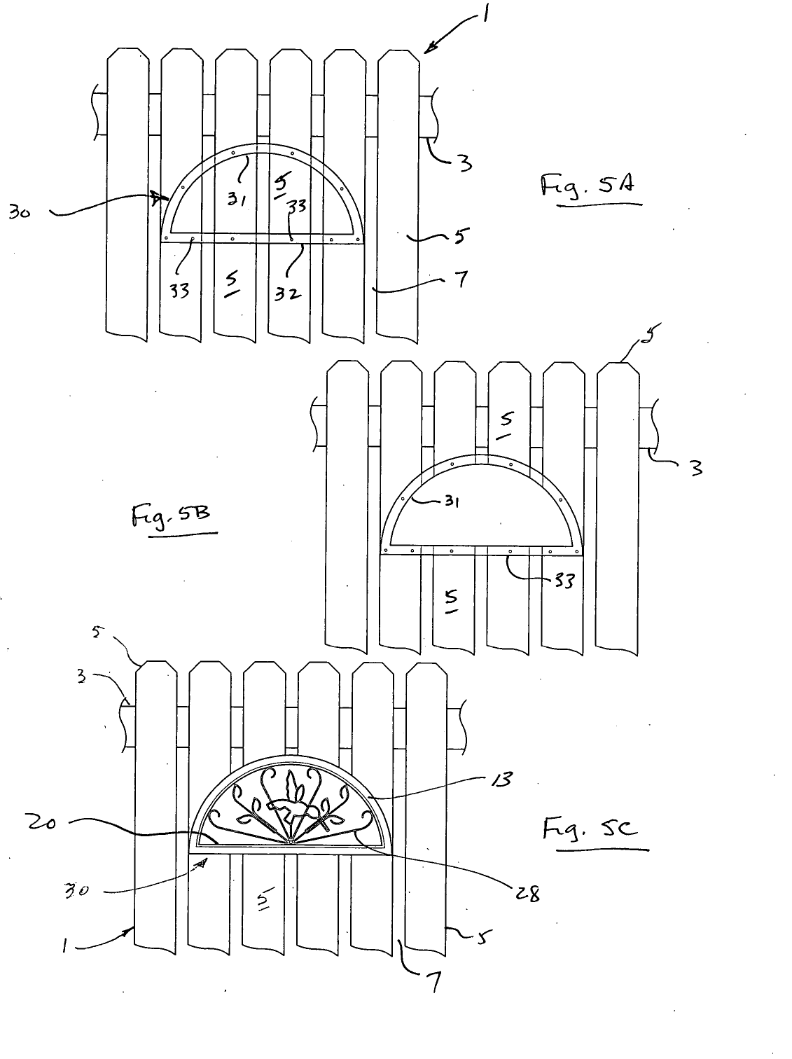

With reference now to the figures, and in particular to FIGS. 1-4, a partition is depicted comprising fence 1 having vertical pickets 5 aligned at their top ends 6 and supported at spaced intervals along their vertical length by horizontal rails 3. Rails 3 in turn are supported by vertical posts (not shown) typically embedded in the ground at selected intervals along the length of fence 1. In the typical fence, at least two rails 3 support pickets 5, each placed approximately one foot from the top and bottom ends of pickets 5. As depicted, pickets 5 comprise planks commonly of cedar or cypress and spaced apart along rails 3 by gaps 7, pickets 5 thereby forming a substantial visual barrier between sides 2, 4 of fence 1. Where fence 1 includes such gaps 7, it does not represent a solid visual barrier, but one having ordinary skill in the art will recognize that some fences 1 may include battens (not shown) covering gaps 7 to provide a continuous visual barrier.

Pickets 5 also are depicted as being vertical members installed all on one side of rails 3 and forming a front 2 and back 4 of fence 1 whereby rails 3 and their supporting posts (not shown) are substantially hidden from view from front side 2 of fence 1. One having ordinary skill in the art will recognize that some fences are built with pickets 5 installed on both sides of fence 1, either aligned or staggered, so that both sides 2, 4 of fence 1 appear to be similar.

Installed through pickets 5 between rails 3, window 10 of the present invention opens a viewing port through fence 1. As depicted and discussed herein, window 10 comprises semicircular opening 11 surrounded by insert 20 and covered by facie trim 13. One having ordinary skill in the art will recognize that the structure and prosedures discussed herein for semicircular opening 11 apply equally well for other shaped openings 11 such as rectangles circles or ovals, and to more exotic shaped openings 11 as well. Insert 20 may include decoration 15 covering a portion of opening 11.

Insert 20 comprises flange 21 abutting the ends of pickets 5 and surrounding opening 11 to form a continuous sill 22a, 22b the shape and size of window 10. Insert 20 fits snugly within opening 11 and spans the thickness of pickets 5. Front edge 23 and opposite back edge 24 of flange 21 protrude a select distance beyond the front 2 and back 4 of pickets 5, 1 creating front and rear overhangs 27, 28. Flange 21 preferably comprises plate steel having a thickness of approximately twenty-two (22 ga.) gauge. Flange 21 may be cut as a single rectangular piece then stamped and folded into its preferred shape and two ends welded to complete its outline.

Flange 21 necessarily may be of various widths, depending upon the figuration of fence 1. For example, where fence 1 has pickets 5 only on one side of rails 3, flange 21 need be only as wide as the thickness of pickets 5 plus overhangs 27, 28. Where fence 1 includes pickets on both sides of rails 3 (not shown), flange 21 must span two layers of pickets 5 as well as the included thickness of rails 3, so that facie 13 sandwich both sets of pickets 5. Where fence 1 includes separate rails 3 supporting pickets 5 on back side 4, flange 21 would be even wider by the width of the second rail 3 and the intervening support posts (not shown). In each case, flange 21 extends beyond front 2 and back 4 of fence 1 by overhangs 27,28 onto which facie 13 attach.

As best seen in FIGS. 1, 3, facie 13 surrounding opening 11 comprise substantially planar trim that surrounds opening 11 and extends radially outward sufficiently to cover the several ends of pickets 5, thereby giving window set 10 a finished appearance. Facie 13 sandwich pickets 5 and window 10 such that they appear substantially identical when viewed from either of sides 2, 4 of fence 1. Facie 13 also serve to confine insert 20 within opening 11, making it unnecessary to affix insert 20 to pickets 5 in any other manner. Facie 13 preferably comprise wood trim, but could be injection molded thermoset plastic or other dimensionally stable synthetic material either colored in the molding process or painted later.

Overhangs 27, 28 are received within notches 17 on the sides of facie 13 adjacent fence 1. Facie 13 preferably are supported by overhangs 27, 28 and need not be attached to window 10 by other means. One having ordinary skill in the art will recognize, however, that fasteners 16 such as screws or nails (FIGS. 1, 3, 5A-5B) could penetrate the front of facie 13 and into pickets 5, likewise holding facie 13 securely to pickets 5 and independently of insert 20.

Decoration 15 as depicted comprises a series of wrought iron elements 29 crossing opening 11 in a decorative manner to lend aesthetic appeal to window 10. Decoration 15 simultaneously creates a screen which prevents large objects or animals from passing through opening 11. One having ordinary skill in the art will recognize that the form of decoration 15 may vary considerably depending upon the purpose of window 10 in each case. For example, decoration 15 might comprise a stained glass (not shown) to lend color and interest, or it could comprise a hinged pet door (not shown) to allow egress and ingress through fence 1 by small animals. Also, decoration 15 could be omitted altogether (FIG. 2) to leave opening 11 unobstructed.

Decoration 15 preferably is centered between sides 2, 4, but could be located toward one of sides 2, 4 (not shown) without departing from the spirit and scope of the present invention. Decoration 15 attaches to inner surface 26 of flange 21 by conventional means appropriate for the type of decoration 15 being employed. For example, as depicted in FIG. 1, wrought iron elements 29 preferably are welded at one point on the lower sill 22a of window 10 and at multiple points along opposite arched roof 22b. For a stained glass window (not shown), attachment means may comprise a specialized frame designed for such purpose and having brackets (not shown) attached to sill 22a and roof 22b.

An important element to the present invention is template 30 disposed between one or both of facie 13 and insert 20. As best seen in FIGS. 5A, 5B, template 30 comprises a substantially flat portion of steel or other structural material shaped to the desired outline of window 10. Template 30 includes inside perimeter 31 matching opening 11 in size and shape and outside perimeter 32 substantially matching the outside perimeter of facie 13. Template 30 is adapted to be affixed to pickets 5 by fasteners 16 which immobilize pickets 5 in anticipation of cutting opening 11 through them.

Fasteners 16 vary according to the particular wall or fence being modified. For example, for the typical residential fence 1, pickets 5 typically are nominally one-by-six (1×6) or one-by-eight (1×8) cedar or cypress planks, and fasteners 16 may be simple screws adapted to penetrate into pickets 5 without protruding through to their opposite sides. For studs in a sheet rock wall (not shown), however, longer and larger fasteners 16, such as lag bolts (not shown), may be required. One having ordinary skill in the art will recognize that all such fasteners 16 are considered to be within the spirit and scope of the present invention.

Template 30 provides structural stability to opening 11 by securing free ends of pickets 5 after opening 11 has been cut. In fact, template 30 is instrumental in preparation and creation of opening 11, as discussed in detail below. Template 30 thus defines the size and shape of opening 11 and remains in place after installation of window 10 to assure stability of pickets 5 after they have been cut and no longer are otherwise supported between rails 3.

Template 30 preferably comprises aircraft aluminum or stainless steel cut from a single sheet so that it is continuous without the necessity of welding. Stainless steel is desirable in outdoor installations such as fence 1 to prevent rust from staining pickets 5 during use. One having ordinary skill in the art will recognize that other materials may be used to secure pickets 5 in other environments, such as indoor walls (not shown). The thickness of template 30 also varies according to the structural strength required. For the application depicted in the figures, namely window 10 penetrating a single layer of pickets 5, template 30 preferably is twenty-four (24 ga.) gauge aircraft aluminum.

In operation, a user (not shown) selects a location within fence 1 for window 10. Such location will be defined by the purpose of window 10. For example, if window 10 is meant to increase visual convenience and acuity through fence 1 for a human of normal height, the vertical location of window 10 might be chosen to be a few a feet above grade to agree with a comfortable viewing height when the person is standing or sitting. If the purpose of window 10 is to provide viewing or ingress and egress for a pet confined behind fence 1, the vertical height of window 10 might be but a few inches above grade. The horizontal location of window 10 should be selected to avoid overlapping support posts (not shown) and rails 3, and to optimize visibility and structural integrity of fence 1. For a pet, this often is through a portion of fence 1 facing toward a street in front of a property, where the pet can see approaching intruders and visitors as well as hear them.

Once the user has selected the height and horizontal location for window 10, he places template 30 against pickets 5 on one side (front 2 or back 4) of fence 1 (FIG. 5A) and fastens it securely to all pickets S with fasteners 16. Where pickets S are installed on both sides 2, 4 of fence 1 (not shown), two templates 30 must be aligned and installed, one on front 2 and the other on back 4. In either case, particular attention is directed to the location of corners 12 of window 10 to assure symmetry between gaps 7 may be maintained if desired. Similarly, attention to minimizing the number of pickets 5 affected should be considered. Of course, where window 10 includes linear sides, such as bottom sill 14, care to keep it horizontal, and otherwise desirable orientations, must be maintained.

Once template 30 has been fastened completely to each picket 5 it touches, and around its entire perimeter, the user uses a saw to cut opening 11 along inside perimeter 31, removing and discarding portions of pickets 5 to create opening 11. See FIG. 5B. In at least some cases, pickets 5 will have been severed entirely, disconnecting the remaining ends thereof from one of their supporting rails 3. However, because template 30 first was fastened securely to such pickets 5, those cut off ends of pickets 5 are not free to move, but are secured in place and remain structurally sound. The user may use a rasp, file of sandpaper to smooth the edges of opening 11 within template 30 if necessary.

Next, the user installs insert 20 within opening 11 (FIG. 5C) and within the inside perimeter 31 of template 30. The user centers flange 21 laterally within opening 11 such that overhangs 27, 28 extend equidistant beyond front 2 and back 4 of fence 1. Where the shape of opening 11 allows for multiple orientations of window 10 (e.g. for round or rectangular openings 11), decoration 15, if present, defines such orientation by its aesthetic functionality within window 10. Facie 13 next are pushed onto the outer surface 25 of flange 21 with overhangs 27, 28 nested snugly within notches 17, thus securing them in place. Fasteners 16 may be used to affix facie 13 to pickets 5 as needed. The installation of window set 10 thereby is completed.

The present invention, described in either its preferred or alternate embodiment, thus serves to create a visually appealing port through a fence or other partition with a minimum of effort. Once affixed to them, template 30 secures vertical support members such as pickets 5 to permit partial or complete severing of their ends from horizontal supports such as rails 3, thereby forming opening 11 into which window 10 may be inserted and affixed. Insert 20 fits snugly within opening 11 and facie 13 receive protruding edges 23, 24 of insert 20 to provide a smooth, even sill for window 10. Decoration 15 may be included to block passage through window 10 of large objects or animals while creating an aesthetically pleasing enhancement.

While the invention has been particularly shown and described with reference to one or more embodiments, it will be understood by those skilled in the art that various changes in form and detail may be made therein without departing from the spirit and scope of the invention. For example, the present invention has been discussed primarily in the context of providing window 10 through fence 1, but it could just as easily serve to put a window through an interior wall of a building, preferably as long as such wall did not bear the load of such building. In such case, template 30 would be affixed directly over wall board (not shown) and directly into its supporting studs, which could then be cut just as discussed above for pickets 5. Installation of window 10 then would proceed as discussed, with facie 13 disposed atop the wall board on both sides of the wall.

I claim:

1. A self-supporting window set for a partition, the partition having a plurality of vertical members spaced along at least two horizontal supports, the partition having a front and a back, the window set comprising
at least one template adapted to attach to the vertical members and having
an outer perimeter and an inner perimeter defining an opening through the partition; and
fastener means coupling the template to the vertical members;
an insert adapted to be received within the opening and having a continuous flange surrounding the opening within the inner perimeter; and
facie means disposed on the overhangs and covering the template and a portion of the vertical members.

2. The window set according to claim 1 and further comprising
decoration means coupled to the flange and disposed within the inner perimeter.

3. The window set according to claim 2 wherein the decoration means comprises
wrought iron elements spanning between opposite sides of the opening.

4. The window set according to claim 2 wherein the decoration means further comprises
door means hingedly coupled to the flange and adapted to hingedly articulate between an open position allowing access through the opening and a closed position preventing such access through the opening.

5. The window set according to claim 4 wherein the door means comprises
a pet door.

6. The window set according to claim 1 wherein
the partition comprises a fence;
the vertical members comprise fence pickets; and
the fastener means comprises a plurality of wood screws penetrating the template and the vertical members.

7. The window set according to claim 1 wherein the facie means comprises
at least one substantially planar trim means having
a front face and a partition face; and
a shape congruent with the template; and
notches disposed on the partition face and surrounding the opening, the notches adapted to receive a portion of the flange for attaching the facie to the insert.

8. The window set according to claim 7 and further comprising
fasteners penetrating the trim means and the vertical members to further secure the trim means to the partition.

9. The window set according to claim 1 and further comprising
overhangs extending from the flange beyond the front and back a spaced distance; and
notches disposed on the partition face and surrounding the opening, the notches adapted to receive the overhangs to further secure the trim means to the partition.

10. A self-supporting window for a fence, the fence comprising vertical pickets supported at spaced intervals by a plurality of horizontal rails and posts, the fence having a front side and a back side, the window comprising
a planar template adapted to couple to the pickets on one of the front and back sides, the template having
an inner perimeter and an outer perimeter; and
a picket face disposed against the front or back side and an opposite front face; and
fastening means for fastening the template to the pickets;
an insert disposed within the inner perimeter and extending through the opening to terminate in overhangs disposed adjacent the front and back sides;
at least one facie disposed on the overhangs and extending radially therefrom to cover the template.

11. The window according to claim 10 and further comprising
a decoration disposed within the opening and coupled to the insert.

12. The window set according to claim 10 wherein the facie means comprises
at least one substantially planar trim means having
a front face and a partition face;
a shape congruent with the template; and
notches disposed on the partition face and surrounding the opening, the notches adapted to receive the overhangs for attaching the facie to the insert.

13. The window according to claim 10 wherein the facie further comprise
notches disposed around an inner perimeter of the facie congruent with the flange and adapted snugly to receive the overhangs for attaching the facie to the insert.

14. The window set according to claim 12 and further comprising
fasteners penetrating the trim means and the vertical members to further secure the trim means to the partition.

15. An improved method of installing a window into a partition, the partition having a front and a back and a plurality of vertical members supported by at least two vertically spaced horizontal supports, the method comprising
providing window set comprising
at least one template adapted to attach to the vertical members and having
an outer perimeter and an inner perimeter defining a size and shape of an opening to be created through the partition; and
fastener means adapted to couple the template to the vertical members;
an insert adapted to be received within the opening and having
a continuous flange surrounding the opening within the inner perimeter; and
overhangs adapted to extend from the flange beyond the front and back of the partition a spaced distance; and
facie means adapted to be disposed on the overhangs and to cover the template and a portion of the vertical members;
selecting a location on the front of the partition for installing the window set; then
coupling the template to the vertical members at the location with the fastener means; then
cutting the vertical members exposed within the inner perimeter to create vertical member ends substantially flush with the inner perimeter and creating an opening through the partition; then
installing the insert within the opening with the flange disposed against the vertical member ends and with the overhangs extending equidistant from the front and the back of the partition; and
installing the facie means onto the overhangs.

16. The improved method of claim 10 wherein
the partition comprises a fence;
the vertical members comprise fence pickets; and
the fastener means comprises a plurality of wood screws penetrating the template and the vertical members.

17. The improved method of claim 10 wherein the facie means comprises
at least one substantially planar trim means having
a front face and a partition face;
a shape congruent with the template; and
notches disposed on the partition face and surrounding the opening, the notches adapted to receive the overhangs for attaching the facie to the insert.

18. The improved method of claim 17 wherein the installing the facie means step comprises
before installing the insert into the opening
positioning the notches of a first facie over the overhangs; then
pressing the first facie against the overhangs until the facie is snugly held onto the flange; then
carrying out the installing the insert step; then
affixing the first facie to the vertical members; then
positioning a second facie onto the overhang opposite the first facie and pressing the second facie onto the overhang; then
affixing the second facie to the vertical members opposite the first facie.
